(19) United States
(12) Patent Application Publication
(10) Pub. No.: US 2026/0189558 A1
(43) Pub. Date: Jul. 2, 2026

(54) MACHINE LEARNING SYSTEM WITH ENTITLEMENT DOMAINS

(71) Applicant: Microsoft Technology Licensing, LLC, Redmond, WA (US)

(72) Inventors: Brian Scott KRABACH, Snohomish, WA (US); Samuel Edward SCHILLACE, Portola Valley, CA (US)

(73) Assignee: Microsoft Technology Licensing, LLC, Redmond, WA (US)

(21) Appl. No.: 19/003,722

(22) Filed: Dec. 27, 2024

(51) Int. Cl. H04L 9/40

(52) U.S. Cl. CPC H04L 63/10; H04L 63/1425

(57) ABSTRACT

A computing system including one or more processing devices configured to execute a machine learning (ML) system including ML agents. The ML agents include a first ML agent that has first entitlement metadata specifying a first entitlement domain that is accessible by the first ML agent and includes resources. The one or more processing devices receive a first entitlement request including selection of a resource included in the first entitlement domain. The first entitlement request further includes second entitlement metadata that specifies a second entitlement domain accessible by a second ML agent. Based at least in part on the first and second entitlement metadata, the one or more processing devices grant the first entitlement request to provide the second ML agent access to the selected resource. At the second ML agent, the one or more processing devices compute and output an agent output based on the selected resource.

### BACKGROUND

In computing environments that have multiple different users, those users typically have different sets of access permissions. Access permissions are used to protect those users' confidential data by controlling which users can interact with which sets of data, and what sets of actions those users are allowed to perform. For example, a first user may have permission to read, edit, and copy a document, whereas a second user has read-only privileges and a third user is entirely blocked from accessing the document. Thus, a computing system may control access to confidential data such as trade secrets or personally identifying information.

The access permissions associated with a particular resource may be stored at the computing system as an access-control list (ACL) that specifies the privileges granted to each user for that resource. Alternatively, role-based access control (RBAC) may be used to specify user permissions. In RBAC, roles that have respective sets of access permissions are assigned to the users of the computing system.

### SUMMARY

According to one aspect of the present disclosure, a computing system is provided, including one or more processing devices configured to execute a machine learning (ML) system including a plurality of ML agents. The plurality of ML agents include a first ML agent that has first entitlement metadata specifying a first entitlement domain that is accessible by the first ML agent and includes a plurality of resources. The one or more processing devices are further configured to receive a first entitlement request including a selection of a resource included among the plurality of resources specified in the first entitlement domain. The first entitlement request further includes second entitlement metadata that specifies a second entitlement domain accessible by a second ML agent included in the ML system. Based at least in part on the first entitlement metadata and the second entitlement metadata, the one or more processing devices are further configured to grant the first entitlement request to thereby provide the second ML agent access to the selected resource. At the second ML agent, the one or more processing devices are further configured to compute an agent output based at least in part on the selected resource. The one or more processing devices are further configured to output the agent output to an additional computing process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1C schematically show a computing system including one or more processing devices configured to execute a machine learning (ML) system including a plurality of ML agents, according to one example embodiment.

FIG. 2A schematically shows the computing system when the one or more processing devices are configured to receive a semantic entitlement 70 that has a natural language format, according to the example of FIGS. 1A-1C.

FIG. 2B schematically shows the computing system when the one or more processing devices are configured to extend a semantically defined entitlement domain, according to the example of FIG. 2A.

FIG. 3A schematically shows the computing system when the one or more processing devices are further configured to compute a confidence value of the entitlement scope determination, according to the example of FIGS. 1A-1C.

FIG. 3B schematically shows a confidence threshold set including a plurality of predefined confidence thresholds, according to the example of FIG. 3A.

FIG. 4 schematically shows the computing system when the one or more processing devices are further configured to receive a second entitlement request, according to the example of FIGS. 1A-1C.

FIG. 5 schematically shows the computing system in an example in which the one or more processing devices are configured to request user approval before granting a second ML agent access to a selected resource, according to the example of FIGS. 1A-1C.

FIG. 6 schematically shows the computing system in an example in which the one or more processing devices are further configured to perform anomaly detection on the first entitlement request, according to the example of FIG. 5.

FIG. 7A shows a flowchart of a method for use with a computing system to control access to different resources by ML agents, according to the example of FIGS. 1A-1C.

FIGS. 7B-7F show additional steps of the method of FIG. 7A that may be performed in some examples.

FIG. 8 shows a schematic view of an example computing environment in which the computing system of FIGS. 1A-1C may be instantiated.

### DETAILED DESCRIPTION

As the capabilities of machine learning (ML) models have advanced, those ML models have been incorporated into a variety of computing workflows. For example, ML models have been incorporated into ML agents that utilize those ML models in at least partially autonomous computing processes. An ML agent includes computer program instructions that specify conditions under which one or more ML models are executed, along with the inputs of those ML models. In some examples, the ML agent may be included in an ML system that includes multiple ML agents capable of interacting with each other. In addition, an ML agent may request user oversight or approval for some specified actions.

Traditional approaches to access permissions in computing environments, such as ACLs and RBAC, provide a static framework with which computing systems provide access to different resources. However, in computing systems that include ML agents, those ML agents may be configured to utilize a variety of different data sources and output channels. In addition, the ML agent and its surrounding computing environment may change over time, for example, as a result of adding new files to a filesystem, modifying a confidentiality policy, or performing additional training at an ML model included in the ML agent. Conventional access control systems may require manual updating to account for such changes.

An ML agent may perform operations on resources at speeds and scales that would make frequent requests for user feedback impractical. For example, requesting user approval to access each file in a large directory may be very time-consuming for the user, especially if the user is not already familiar with the contents of those files. Requesting user feedback as a prerequisite to accessing a resource may also interrupt a user's workflow, such as when an ML agent requests permission from a meeting organizer to join an ongoing meeting on a videoconferencing platform. However, automating permission assignment in an ML system raises the possibility inaccurate permission assignments, which may result in unintended data disclosure. Inaccurate permission assignment may also result in an ML agent having too few permissions to perform a user's intended action.

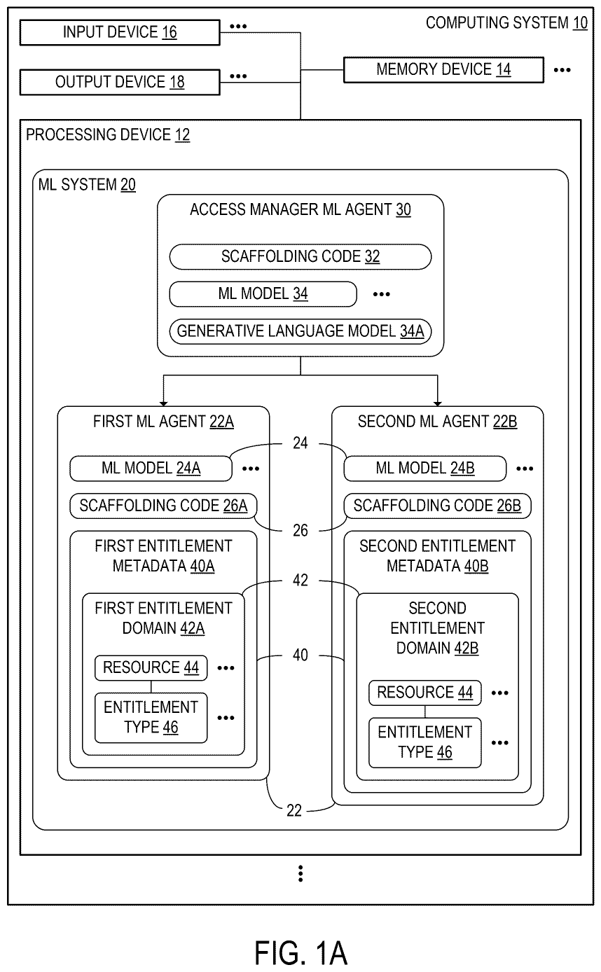

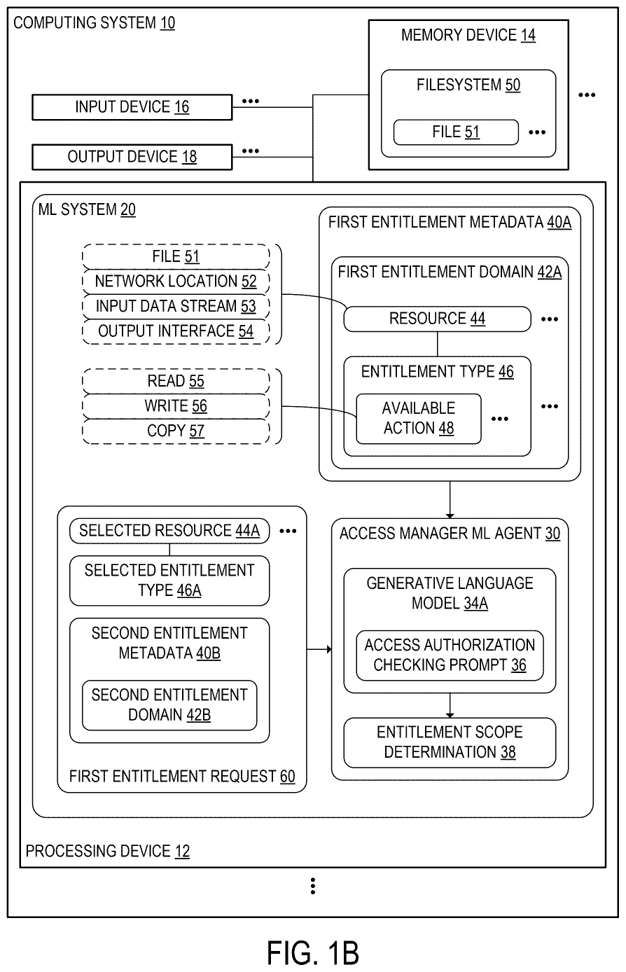

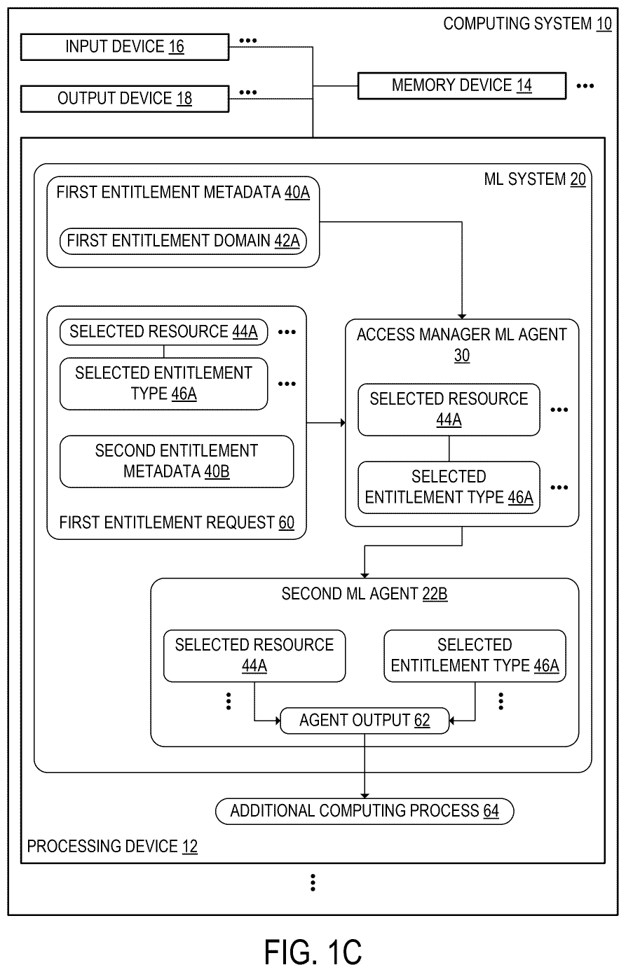

In order to address the above challenges, a computing system 10 is provided, as shown in the example of FIGS. 1A-1C. The computing system 10 of FIGS. 1A-1C includes one or more processing devices 12, one or more memory devices 14, one or more input devices 16, and one or more output devices 18. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices. The one or more input devices 16 and the one or more output devices 18 are used to implement a user interface at which a user interacts with the computing system 10, as discussed in further detail below.

In some examples, the one or more processing devices 12, the one or more memory devices 14, the one or more input devices 16, and/or the one or more output devices 18 may be distributed among a plurality of different physical computing devices. For example, the physical computing devices included in the computing system 10 may have a server-client configuration. In other examples, the computing system 10 may be implemented at a single physical computing device.

The one or more processing devices 12 are configured to execute an ML system 20 that includes a plurality of ML agents 22. Each of the ML agents 22 includes one or more ML models 24 along with scaffolding code 26. The one or more processing devices 12 are configured to execute the scaffolding code 26 to determine when the one or more ML models 24 are executed and to select the inputs to those ML models 24. Preprocessing of those inputs and/or postprocessing of ML model outputs may also be performed by executing the scaffolding code 26. The one or more ML models 24 may, for example, include one or more large language models (LLMs), small language models (SLMs) and/or large multimodal models (LMMs). For example, GPT-3, GPT-3.5, GPT-4o, Orca, LLAMA, Gemini, Claude v1, or Phi-3-mini may be used as the LLM, SLM, or LMM. Further, it will be understood that language models of various parameter sizes may be used, with smaller models generally having lower hardware requirements and offering lower latency, and larger models having higher hardware requirements and offering greater accuracy and expressiveness. The LLM, SLM, or LMM may be fine-tuned using, for example, full finetuning, delta models, Low Rank Adaptation (LoRA) models, or some other technique. Other types of ML models 24, such as computer vision models or audio processing models, may also be included in an ML agent 22.

In the example of FIGS. 1A-1C, the ML system 20 includes an access manager ML agent 30. As discussed in further detail below, the access manager ML agent 30 is configured to control the access permissions that the other ML agents 22 included in the ML system 20 have to different resources 44. The access manager ML agent 30 includes one or more ML models 34. In the example of FIGS. 1A-1B, the access manager ML agent 30 includes a generative language model 34A, which may be an LLM, an SLM, or an LMM, among the one or more ML models 34. In addition, the access manager ML agent 30 includes scaffolding code 32 that is executed to determine when the one or more ML models 34 are executed, as well as to preprocess inputs and/or postprocess outputs of the one or more ML models 34.

In other examples, rather than using an access manager ML agent 30, the one or more processing devices 12 may instead be configured to control access to different resources 44 in a manner that is distributed among the plurality of different ML agents 22. For example, such a configuration without a centralized access manager ML agent 30 may be used in examples in which the ML agents are executed on a plurality of different physical computing devices. In such examples, use of a centralized access manager ML agent 30 may incur high latency due to communication delays between those physical computing devices.

In some examples, as discussed in further detail below, the access manager ML agent 30 is configured to assign respective entitlement metadata 40 to the other ML agents 22 included in the ML system 20. The entitlement metadata 40 of an ML agent 22 specifies an entitlement domain 42 that includes a plurality of resources 44 to which the ML agent 22 has access. FIG. 1B shows examples of different types of resources 44. In the example of FIG. 1B, the one or more memory devices 14 store a filesystem 50 including a plurality of files 51. The plurality of resources 44 may include one or more of the files 51 stored in the filesystem 50. As another example, a resource 44 may be a network location 52 in a computer network. A resource 44 may alternatively be an input data stream 53 received at the computing system 10 or an output interface 54 of the computing system 10. The input data stream 53 and the output interface 54 may be associated with an input device 16 and an output device 18, respectively. Other types of resources 44 may be accessible to an ML agent 22 in other examples.

In addition to the plurality of resources 44, the entitlement domain 42 may further include a respective plurality of entitlement types 46 associated with the resources 44. The entitlement types 46, in such examples, are respective sets of available actions 48 performable on the resources 44. Examples of such available actions 48 shown in FIG. 1B are read 55, write 56, and copy 57. Other types of available actions 48 may additionally or alternatively be specified in an entitlement type 46 in other examples.

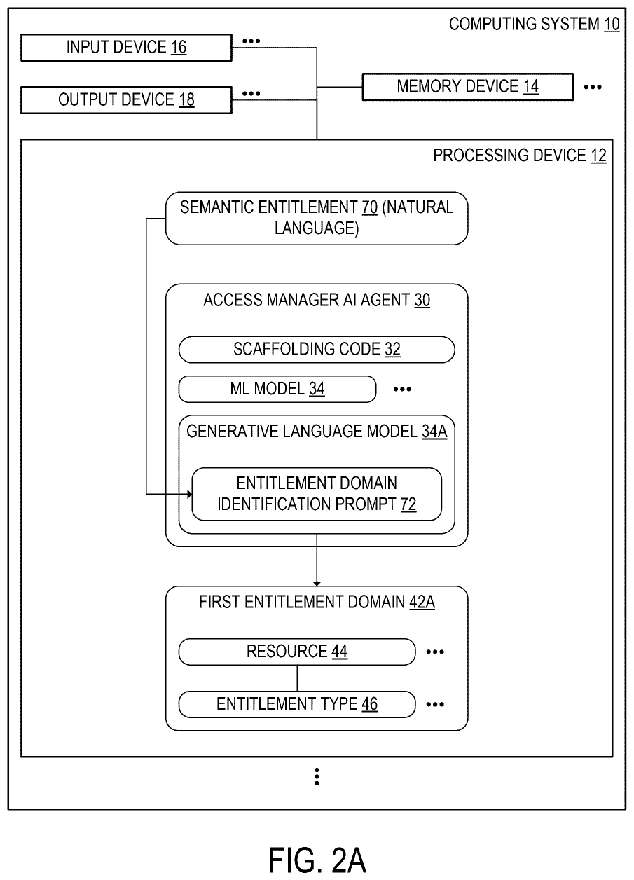

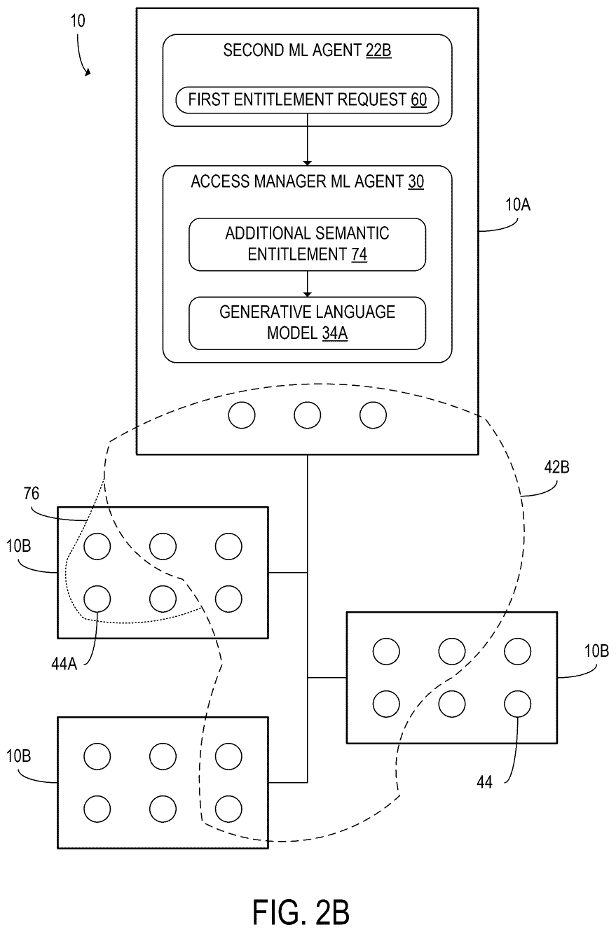

In some examples, the entitlement domains 42 of the ML agents 24 may be semantically defined. FIG. 2A schematically shows the computing system 10 in an example in which the one or more processing devices 12 are configured to receive a semantic entitlement 70 that has a natural language format. The semantic entitlement 70 may be defined via user input. As one example, the one or more processing devices 12 may be configured to receive the semantic entitlement “Give the appointment scheduling agent access to the calendar and to work-related emails.” Another example semantic entitlement is “Allow the summary generating agent to store files on the shared network drive.” A semantic entitlement 70 may accordingly refer to a set of resources that would be difficult to specify with previous approaches such as ACLs or RBAC. The semantic entitlement 70 may be included in the entitlement metadata 40 in some examples. For example, the first entitlement metadata 40A and/or the second entitlement metadata 40B may be received as a semantic entitlement 70.

In the example of FIG. 2A, the one or more processing devices 12 are further configured to compute the first entitlement domain 42A at least in part by executing the generative language model 34A at the access manager ML agent 30 with an entitlement domain identification prompt 72 that includes the semantic entitlement 70. The access manager ML agent 30 may, in some examples, be configured to generate the first entitlement domain 42A as an explicit list of resources 44 with corresponding access types. The entitlement types 46 associated with the resources 44 may also be computed at least in part at the generative language model 34A in such examples.

Returning to FIG. 1A, the plurality of ML agents 22 include a first ML agent 22A. The first ML agent 22A includes one or more ML models 24A and scaffolding code 26A. In addition, the first ML agent 22A has first entitlement metadata 40A specifying a first entitlement domain 42A that is accessible by the first ML agent 22A. The first entitlement domain 42A includes a plurality of resources 44, along with a respective plurality of entitlement types 46 associated with the resources 44. The plurality of ML agents 22 further include a second ML agent 22B. The second ML agent 22B includes one or more ML models 24B and scaffolding code 26B. The second ML agent 22B has second entitlement metadata 40B that specifies a second entitlement domain 42B accessible by the second ML agent 22B. The second entitlement domain 42B also includes a plurality of resources 44 with corresponding entitlement types 46.

As shown in the example of FIGS. 1B-1C, the one or more processing devices 12 are further configured to receive a first entitlement request 60. For example, the first entitlement request 60 may be received as a user input. As another example, the first entitlement request 60 may be an output of the second ML agent 22B. The first entitlement request 60 includes a selection of a resource 44A included among the plurality of resources 44 specified in the first entitlement domain 42B. In some examples, the first entitlement request 60 specifies a plurality of selected resources 44A. The first entitlement request 60 further includes the second entitlement metadata 40B that specifies the second entitlement domain 42B accessible by the second ML agent 22B. The first entitlement request 60 may further specify a selected entitlement type 46A associated with the selected resource 44A. In some examples, at least a portion of the first entitlement request 60 may have a natural-language format. For example, the selected resource 44A, the selected entitlement type 46A, and/or the second entitlement metadata 40B may be specified with a natural-language descriptor.

The one or more processing devices 12 are be configured to receive and process the first entitlement request 60 at the access manager ML agent 30. In examples in which an access manager ML agent 30 is not used, the one or more processing devices may instead be configured to receive and process the first entitlement request 60 at the first ML agent 22A. In the example of FIGS. 1A-1C, based at least in part on the first entitlement metadata 40A and the second entitlement metadata 40B, the one or more processing devices 12 are further configured to grant the first entitlement request 60 to thereby provide the second ML agent 22B access to the selected resource 44A. The one or more processing devices 12 are accordingly configured to determine that the selected resource 44A is within the second entitlement domain 42B.

In the example of FIG. 1B, the one or more processing devices 12 are configured to determine that the selected resource 44A is within the second entitlement domain 42B at least in part by executing the generative language model 34A with an access authorization checking prompt 36 that includes the first entitlement metadata 40A and the first entitlement request 60. The generative language model 34A is configured to output an entitlement scope determination 38 in such examples. In some examples, the one or more processing devices 12 are configured to determine that the selected resource 44A has an entitlement type 46 within the second entitlement domain 42B that includes the selected entitlement type 46A requested in the first entitlement request 60.

The one or more processing devices 12 are further configured to grant the first entitlement request 60 in response to determining that the selected resource 44A is within the second entitlement domain 42B. The one or more processing devices 12 are accordingly configured to determine that the second ML agent 22B has permission to access the selected resource 44A with the selected entitlement type 46A.

At the second ML agent 22B, as shown in the example of FIG. 1C, the one or more processing devices 12 are further configured to compute an agent output 62 based at least in part on the selected resource 44A. In examples in which the selected resource 44A has a corresponding selected entitlement type 46A, the second ML agent 22B may access the selected resource 44A with the selected entitlement type 46A when computing the agent output 62. For example, when the selected resource 44A is a file 51 stored in a filesystem 50, the second ML agent 22B may be configured to process data stored in the file 51 at the one or more ML models 24B when computing the agent output 62.

At the second ML agent 22B, the one or more processing devices 12 are further configured to output the agent output 62 to an additional computing process 64. For example, the agent output 62 may be presented to the user at a user interface. As another example, the second ML agent 22B may transmit the agent output 62 to another ML agent 22 included in the ML system 20.

FIG. 2B schematically shows the computing system 10 when the second entitlement domain 42B of the second ML agent 22B is extended in response to receiving the first entitlement request 60. In the example of FIG. 2B, the computing system 10 includes a plurality of physical computing devices. The access manager ML agent 30 is executed at a first physical computing device 10A, which also stores a subset of the plurality of resources 44. Other resources 44 are located at additional physical computing devices 10B.

In the example of FIG. 2B, the second entitlement domain 42B is computed at the access manager ML agent 30 based at least in part on an additional semantic entitlement 74, similarly to how the first entitlement domain 42A is computed using the semantic entitlement 70 in the example of FIG. 2A. The second entitlement domain 42B includes a plurality of the resources 44 across multiple different physical computing devices, including the first physical computing device 10A and the additional physical computing devices 10B.

When the first entitlement request 60 is granted, the one or more processing devices 12 of the first physical computing device 10A are configured to recompute the second entitlement domain 42B. The second entitlement domain 42B may be recomputed at least in part by executing the generative language model 34A with an input that includes the additional semantic entitlement 74 and the first entitlement request 60. The one or more processing devices 12 are configured to compute an entitlement domain extension 76 that includes one or more selected resources 44A not previously included in the second entitlement domain 42B. Thus, the one or more processing devices 12 are configured to recompute the second entitlement domain 42B when the second ML agent 22B is granted access to the selected resources 44A.

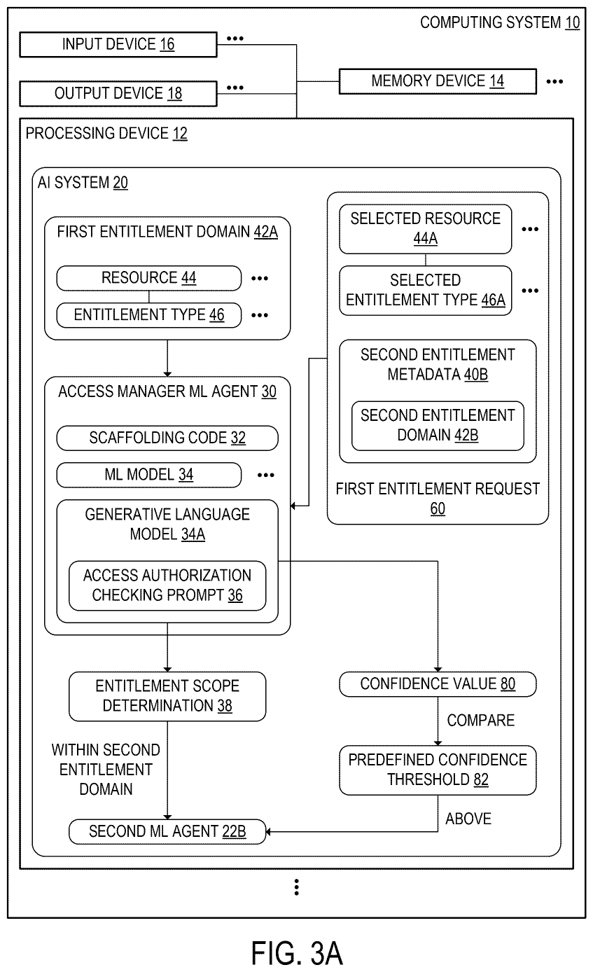

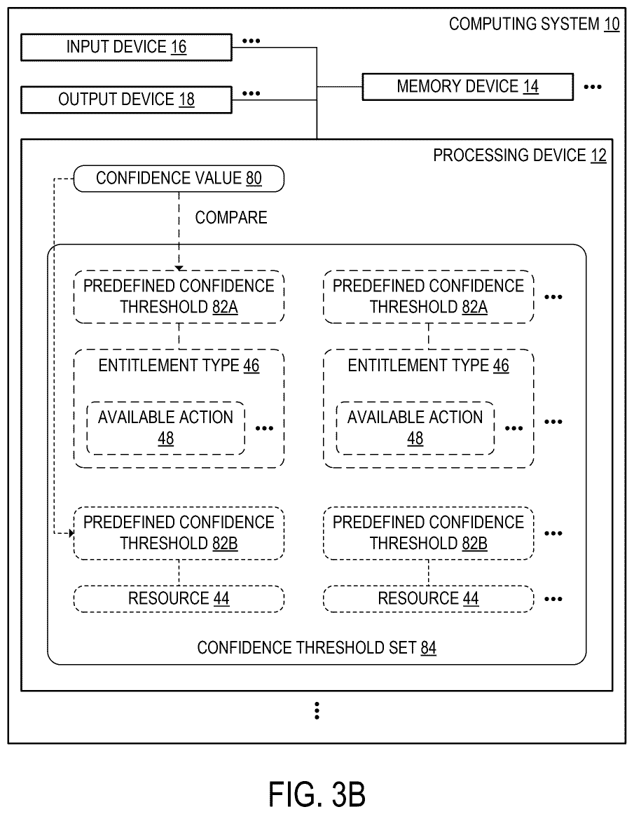

FIG. 3A schematically shows the computing system 10 in further detail when the one or more processing devices 12 are configured to process the first entitlement request 60 at the access manager ML agent 30. In the example of FIG. 3A, the one or more processing devices 12 are further configured to compute a confidence value 80 of the entitlement scope determination 38. Accordingly, the confidence value 80 indicates a confidence that the selected resource 44A is within the second entitlement domain 42B. The one or more processing devices 12 may be configured to compute the confidence value 80 at least in part at the generative language model 34A. For example, the confidence value 80 may be computed from a variance in an output token distribution of the generative language model 34A. The one or more processing devices 12 are further configured to grant the first entitlement request 60 in response to determining that the confidence value 80 is above a predefined confidence threshold 82.

In some examples, as shown in FIG. 3B, the predefined confidence threshold 82 may be included among a plurality of different predefined confidence thresholds 82 included in a confidence threshold set 84. For example, the confidence threshold set 84 may include a plurality of predefined confidence thresholds 82A associated with respective entitlement types 46. Thus, for example, the access manager ML agent 30 may grant the second ML agent 22B permission to read a file at a lower confidence value 80 than the value at which the access manager ML agent 30 grants the second ML agent 22B permission to write to the file or copy the file. Additionally or alternatively, the confidence threshold set 84 may include a plurality of predefined confidence thresholds 82B associated with different respective resources 44 of the plurality of resources 44. Thus, some resources 44 may be marked as having higher sensitivity than other resources 44.

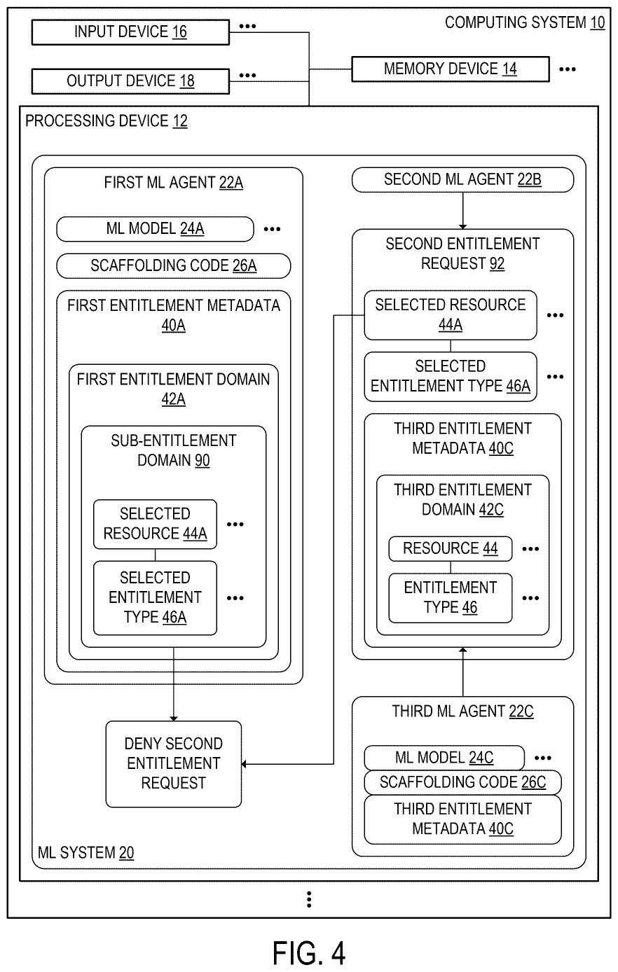

FIG. 4 schematically shows the computing system 10 in an example in which the first entitlement domain 42A includes a sub-entitlement domain 90 that is specified as a proper subset of the first entitlement domain 42A. The sub-entitlement domain 90 includes the selected resource 44A. A selected entitlement type 46A of the selected resource 44A is also specified within the sub-entitlement domain 90 in the example of FIG. 4.

The sub-entitlement domain 90 indicates the resources 44 it includes as non-transferable. In the example of FIG. 4, the one or more processing devices 12 are further configured to receive a second entitlement request 92 from the second ML agent 22B. The access manager ML agent 30 may process the second entitlement request 92. The second entitlement request 92 includes a selection of the selected resource 44A. The second entitlement request 92 may further include the selected entitlement type 46A of the selected resource 44A. In addition, the second entitlement request 92 includes third entitlement metadata 40C that specifies a third entitlement domain 42C accessible by a third ML agent 22C included in the ML system 20. The third ML agent 22C includes one or more ML models 24C, scaffolding code 26C, and the third entitlement metadata 40C. The third entitlement metadata 40C includes a third entitlement domain 42C including a plurality of resources 44 and their respective entitlement types 46.

The one or more processing devices 12 are further configured to deny the second entitlement request 92 based at least in part on the selected resource 44A being included in the sub-entitlement domain 90. Thus, the sub-entitlement domain 90 specifies one or more resources 44 as not being transferable from the second ML agent 22B to other ML agents 22 after those one or more resources 44 are transferred from the first ML agent 22A to the second ML agent 22B. Controlling access transfer using the sub-entitlement domain 90 allows the ML system 20 to limit the scope of errors that could result in unauthorized access to resources 44.

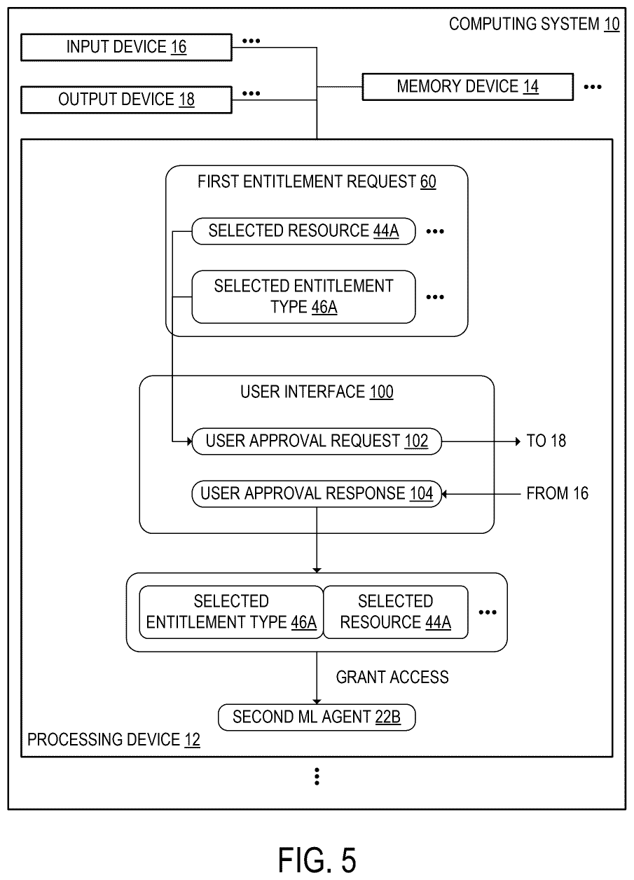

FIG. 5 schematically shows the computing system 10 in an example in which the one or more processing devices 12 are configured to request user approval before granting the second ML agent 22B access to a selected resource 44A. In the example of FIG. 5, the one or more processing devices 12 are further configured to output a user approval request 102 to a user interface 100 prior to granting the second ML agent 22B access to the selected resource 44A. The user approval request 102 may indicate the selected resource 44A and the selected entitlement type 46A. The user interface 100 may, for example, be a graphical user interface (GUI) displayed at a display device included among the one or more output devices 18.

The one or more processing devices 12 are further configured to receive a user approval response 104 via the user interface 100 subsequently to outputting the user approval request 102. The user approval response 104 may be received via the one or more input devices 16 included in the computing system 10. The one or more processing devices 12 are further configured to grant the second ML agent 22B access to the selected resource 44A in response to receiving the user approval response 104. In other examples, the user may deny the user approval request 102. Thus, in the example of FIG. 5, the one or more processing devices 12 are configured to request user approval as a prerequisite for granting the second ML agent 22B access to the selected resource 44A.

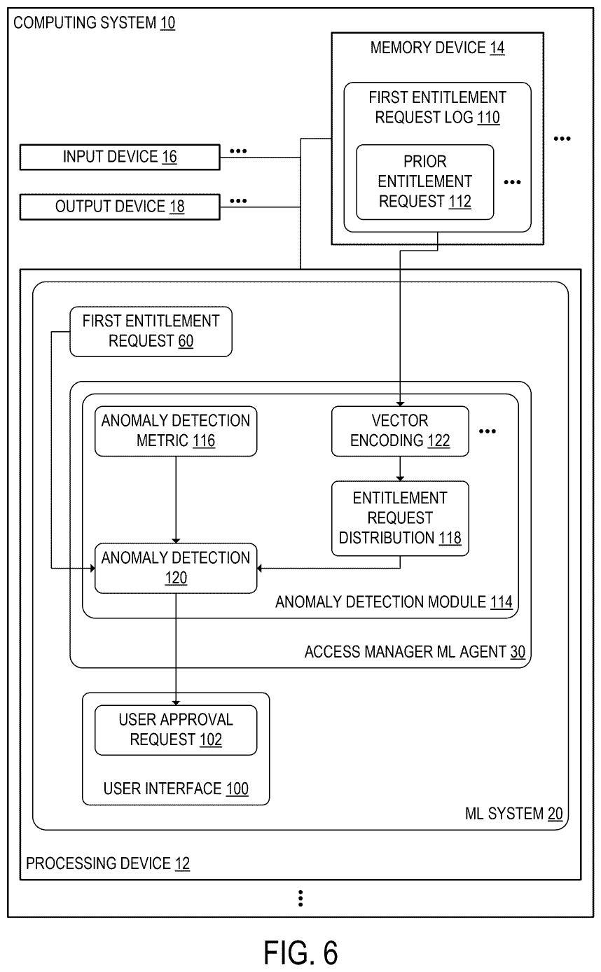

FIG. 6 schematically shows the computing system 10 in an example in which the one or more processing devices 12 are further configured to perform anomaly detection at the ML system 20. Performing anomaly detection includes storing, in the one or more memory devices 14, an entitlement request log 110 that includes a plurality of prior entitlement requests 112. The prior entitlement requests 112 are entitlement requests that have previously been made at the ML system 20 before the first entitlement request 60.

In the example of FIG. 6, the one or more processing devices 12 are further configured to execute an anomaly detection module 114. For example, the anomaly detection module 114 may be included in the access manager ML agent 30. At the anomaly detection module 114, the one or more processing devices 12 are further configured to determine, based at least in part on the plurality of prior entitlement requests 112, that the first entitlement request 60 is an outlier compared to the plurality of prior entitlement requests 112 according to at least one anomaly detection metric 116. The one or more processing devices 12 are accordingly configured to compute an anomaly detection 120.

As shown in the example of FIG. 6, the one or more processing devices 12 may be configured to compute an entitlement request distribution 118 of one or more statistical properties of the plurality of prior entitlement requests 112. The entitlement request distribution 118 may, in such examples, be computed as a distribution of vector encodings 122 of the prior entitlement requests 112. In examples in which the one or more processing devices 12 are configured to receive a plurality of semantic entitlements 70, as discussed above with reference to FIG. 2A, the vector encodings 122 may accordingly encode the semantic contents of the prior entitlement requests 112. When the anomaly detection 120 is computed, the one or more processing devices 12 may be configured to determine that a vector encoding of the first entitlement request 60 is an outlier relative to the entitlement request distribution 118 of the vector encodings 122 of the prior entitlement requests 112.

In response to determining that the first entitlement request 60 is an outlier, the one or more processing devices 12 are further configured to output the user approval request 102 to the user interface 100. The one or more processing devices 12 may accordingly be configured to request user approval of entitlement requests that significantly deviate from previous entitlement request patterns. This anomaly detection may allow the user to identify erroneous or malicious entitlement requests.

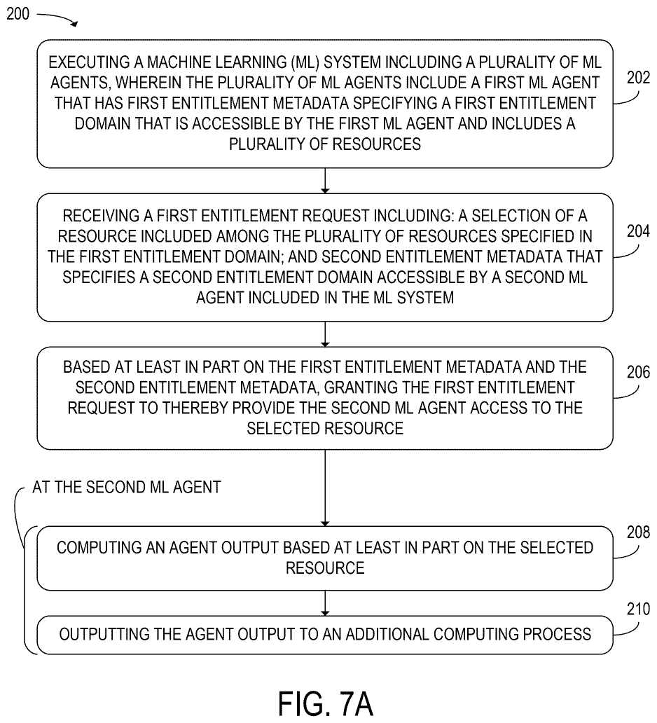

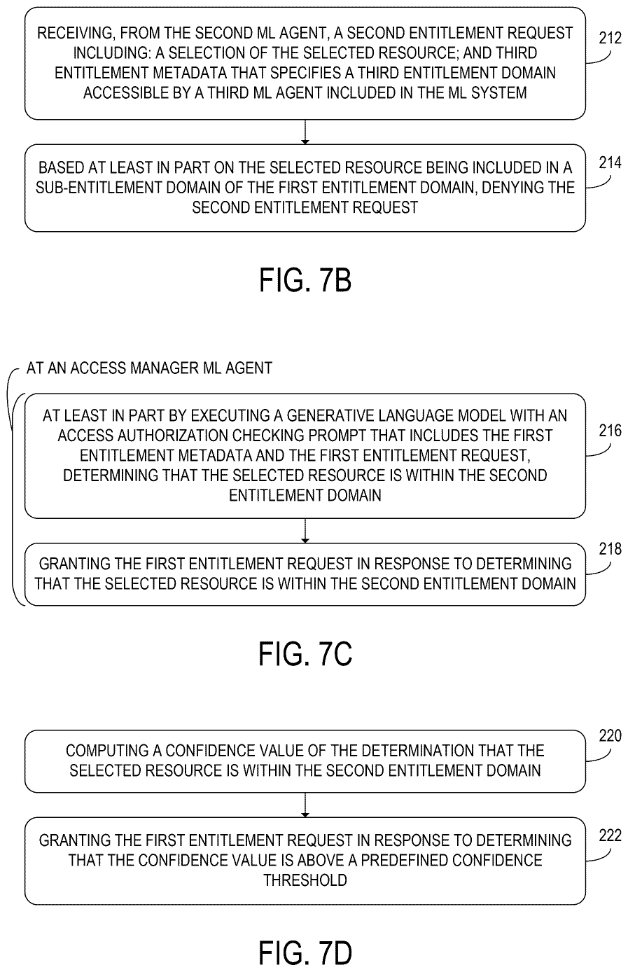

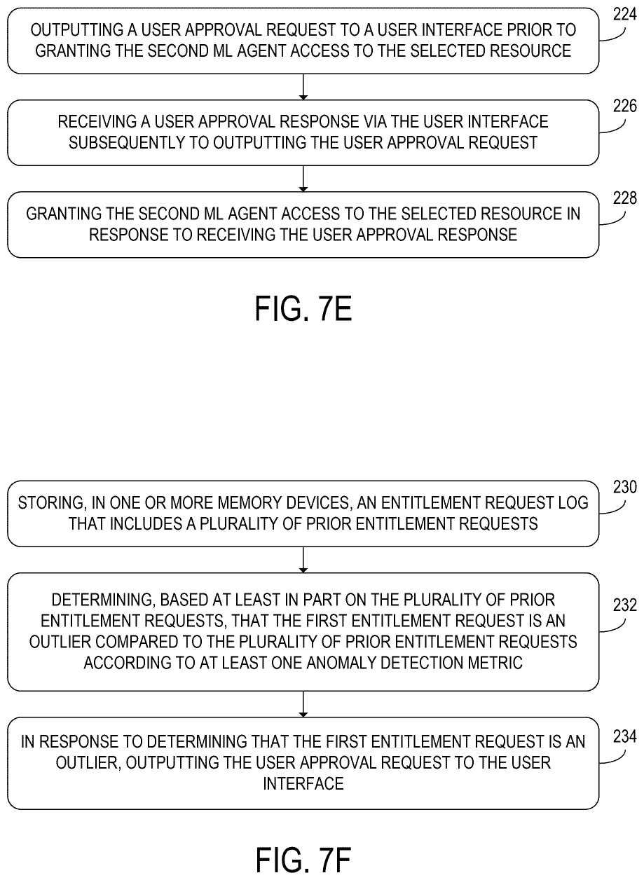

FIG. 7A shows a flowchart of a method 200 for use with a computing system to control access to different resources by ML agents. The method 200 includes, at step 202, executing an ML system including a plurality of ML agents. The plurality of ML agents include a first ML agent that has first entitlement metadata. The first entitlement metadata specifies a first entitlement domain that is accessible by the first ML agent and includes a plurality of resources. The plurality of resources may include a file stored in a filesystem at one or more memory devices, a network location in a computer network, an input data stream received at the computing system, and/or an output interface of the computing system.

At step 204, the method 200 further includes receiving a first entitlement request. The first entitlement request includes a selection of a resource included among the plurality of resources specified in the first entitlement domain. A plurality of resources may be specified in the first entitlement request in some examples. The first entitlement request further includes second entitlement metadata that specifies a second entitlement domain accessible by a second ML agent included in the ML system.

In some examples, the first entitlement domain further includes a respective plurality of entitlement types associated with the resources. In such examples, the entitlement types are respective sets of available actions performable on the selected resource. For example, the available actions may be reading, writing, and copying a file stored in a filesystem. The first entitlement request further specifies a selected entitlement type associated with the selected resource.

At step 206, the method 200 further includes granting the first entitlement request based at least in part on the first entitlement metadata and the second entitlement metadata. The computing system thereby provides the second ML agent access to the selected resource. In examples in which the first entitlement request includes a selected entitlement type, the access the second ML agent is granted may have that selected entitlement type. Step 206 may be performed at an access manager ML agent in some examples. In other examples, step 206 may be performed at the first ML agent.

Steps 208 and 210 of the method 200 are performed at the second ML agent. At step 208, the method 200 further includes computing an agent output based at least in part on the selected resource. At step 210, the method 200 further includes outputting the agent output to an additional computing process. For example, the additional computing process may be a user interface or another ML agent.

FIGS. 7B-7F show additional steps of the method 200 that may be performed in some examples. The steps of FIG. 7B may be performed in examples in which the first entitlement domain includes a sub-entitlement domain that is specified as a proper subset of the first entitlement domain. The sub-entitlement domain includes the selected resource. At step 212, the method 200 may further include receiving, from the second ML agent, a second entitlement request including a selection of the selected resource. The second entitlement request may further include third entitlement metadata that specifies a third entitlement domain accessible by a third ML agent included in the ML system.

At step 214, based at least in part on the selected resource being included in the sub-entitlement domain, the method 200 may further include denying the second entitlement request. The sub-entitlement domain may therefore indicate one or more resources that are not transferable from initial recipient ML agents to further recipient ML agents.

FIG. 7C shows additional steps that may be performed in examples in which the ML system includes an access manager ML agent that includes a generative language model. At step 216, the method 200 may further include, at the access manager ML agent, determining that the selected resource is within the second entitlement domain. This determination may be made at least in part by executing the generative language model with an access authorization checking prompt that includes the first entitlement metadata and the first entitlement request.

In the example of FIG. 7C, the first entitlement domain and/or the second entitlement domain may be computed from a respective semantic entitlement that has a natural language format. The access manager may, in such examples, process a semantic entitlement at the generative language model to compute the corresponding entitlement domain. The semantic entitlement may be included in the entitlement metadata of the corresponding ML agent.

FIG. 7D shows additional steps of the method 200 that may be performed, for example, at the access manager ML agent. At step 220, the method 200 may further include computing a confidence value of the determination that the selected resource is within the second entitlement domain. At step 222, the method 200 may further include granting the first entitlement request in response to determining that the confidence value is above a predefined confidence threshold. In some examples, the predefined confidence threshold is included among a plurality of different predefined confidence thresholds associated with respective entitlement types. Additionally or alternatively, the predefined confidence threshold is included among a plurality of different predefined confidence thresholds associated with different respective resources of the plurality of resources. Thus, resources and/or entitlement types that have different levels of sensitivity, or that allow different amounts of control, may have different predefined confidence levels at which access is granted.

FIG. 7E shows additional steps of the method 200 that may be performed in some examples. At step 224, the method 200 may further include outputting a user approval request to a user interface prior to granting the second ML agent access to the selected resource. At step 226, the method 200 may further include receiving a user approval response via the user interface subsequently to outputting the user approval request. At step 228, the method 200 may further include granting the second ML agent access to the selected resource in response to receiving the user approval response. The ML system may therefore check for a user's approval before granting the second ML agent access to the selected resource.

FIG. 7F shows additional steps of the method 200 that may be performed in examples in which the steps of FIG. 7E are performed. At step 230, the method 200 may further include storing, in one or more memory devices, an entitlement request log that includes a plurality of prior entitlement requests. At step 232, the method 200 may further include determining, based at least in part on the plurality of prior entitlement requests, that the first entitlement request is an outlier compared to the plurality of prior entitlement requests according to at least one anomaly detection metric. For example, step 232 may include comparing a vector representation of the first entitlement request to a distribution of vector representations of the prior entitlement requests. At step 234, in response to determining that the first entitlement request is an outlier, the method 200 may further include outputting the user approval request to the user interface. The steps of FIG. 7E may accordingly be performed in response to detecting that the first entitlement request is an outlier.

The systems and methods discussed above are used to control access to different resources among the plurality of ML agents included in an ML system. The different ML agents have different respective entitlement domains, which may, in some examples, be defined in a semantic manner rather than with explicit roles or ACLs. To determine whether to transfer resource access between ML agents, the ML system determines whether a selected resource in the first entitlement domain of the first ML agent is also within a second entitlement domain of the second ML agent. By making this determination, the ML agent determines when the first ML agent has permission to share the selected resource with the second ML agent.

In one example use case scenario, different teams within a company have different sets of resources they are allowed to access. For example, those teams may be working on different confidential projects that have respective permission-locked directories within a filesystem. Each of those teams uses a respective administrative assistant ML agent that has access to the team's permission-locked directory. However, not all files stored in each team's directory include confidential information. The above systems and methods of ML agent permission transfer may be used to determine whether a first ML agent used by a first team is allowed to grant a second ML agent used by a second team access to a file stored in the first team's permission-locked directory.

The methods and processes described herein are tied to a computing system of one or more computing devices. In particular, such methods and processes can be implemented as a computer-application program or service, an application-programming interface (API), a library, and/or other computer-program product.

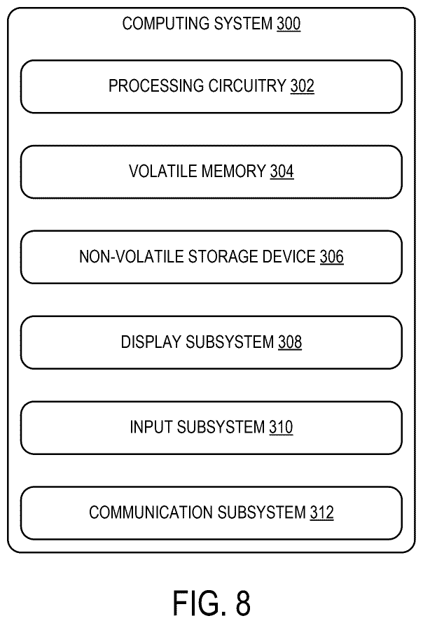

FIG. 8 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 8.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to execute a machine learning (ML) system including a plurality of ML agents. The plurality of ML agents include a first ML agent that has first entitlement metadata specifying a first entitlement domain that is accessible by the first ML agent and includes a plurality of resources. The one or more processing devices are further configured to receive a first entitlement request including a selection of a resource included among the plurality of resources specified in the first entitlement domain. The first entitlement request further includes second entitlement metadata that specifies a second entitlement domain accessible by a second ML agent included in the ML system. Based at least in part on the first entitlement metadata and the second entitlement metadata, the one or more processing devices are further configured to grant the first entitlement request to thereby provide the second ML agent access to the selected resource. At the second ML agent, the one or more processing devices are further configured to compute an agent output based at least in part on the selected resource. The one or more processing devices are further configured to output the agent output to an additional computing process. The above features may have the technical effect of transferring access to the selected resource between different ML agents included in the ML system.

According to this aspect, the first entitlement domain may include a sub-entitlement domain that is specified as a proper subset of the first entitlement domain and includes the selected resource. The one or more processing devices may be further configured to receive, from the second ML agent, a second entitlement request including a selection of the selected resource. The second entitlement request may further include third entitlement metadata that specifies a third entitlement domain accessible by a third ML agent included in the ML system. Based at least in part on the selected resource being included in the sub-entitlement domain, the one or more processing devices may be further configured to deny the second entitlement request. The above features may have the technical effect of making the selected resource non-transferable from the second ML agent to other ML agents.

According to this aspect, the ML system may include an access manager ML agent that includes a generative language model. At the access manager ML agent, the one or more processing devices may be further configured to determine that the selected resource is within the second entitlement domain at least in part by executing the generative language model with an access authorization checking prompt that includes the first entitlement metadata and the first entitlement request. The one or more processing devices may be further configured to grant the first entitlement request in response to determining that the selected resource is within the second entitlement domain. The above features may have the technical effect of using the semantic processing capabilities of the generative language model to determine whether the first entitlement request is granted.

According to this aspect, the one or more processing devices may be further configured to compute a confidence value of the determination that the selected resource is within the second entitlement domain. The one or more processing devices may be further configured to grant the first entitlement request in response to determining that the confidence value is above a predefined confidence threshold. The above features may have the technical effect of determining whether to grant the first entitlement request based on a probabilistic determination of whether the selected resource is within the second entitlement domain.

According to this aspect, the predefined confidence threshold may be included among a plurality of different predefined confidence thresholds associated with respective entitlement types. The entitlement types may be respective sets of available actions performable on the selected resource. The above features may have the technical effect of requiring different confidence levels for the second ML agent to be granted different levels of control over the selected resource.

According to this aspect, the predefined confidence threshold may be included among a plurality of different predefined confidence thresholds associated with different respective resources of the plurality of resources. The above features may have the technical effect of requiring different confidence levels for access to resources that have different levels of sensitivity.

According to this aspect, the one or more processing devices may be configured to compute the first entitlement domain at least in part by executing the generative language model with an entitlement domain identification prompt that includes a semantic entitlement. The semantic entitlement may have a natural language format. The above features may have the technical effect of semantically defining the first entitlement domain.

According to this aspect, the first entitlement domain may further include a respective plurality of entitlement types associated with the resources. The entitlement types may be respective sets of available actions performable on the selected resource. The first entitlement request may further specify a selected entitlement type associated with the selected resource. The above features may have the technical effect of specifying what actions the second ML agent is granted permission to perform with the selected resource.

According to this aspect, the plurality of resources may include a file stored in a filesystem at one or more memory devices, a network location in a computer network, an input data stream received at the computing system, and/or an output interface of the computing system. The above features may have the technical effect of granting the second ML agent access to different types of resources.

According to this aspect, the one or more processing devices may be further configured to output a user approval request to a user interface prior to granting the second ML agent access to the selected resource. The one or more processing devices may be further configured to receive a user approval response via the user interface subsequently to outputting the user approval request. The one or more processing devices may be further configured to grant the second ML agent access to the selected resource in response to receiving the user approval response. The above features may have the technical effect of requesting user approval before granting the second ML agent access to the selected resource.

According to this aspect, the one or more processing devices may be further configured to perform anomaly detection at the ML system at least in part by storing, in one or more memory devices, an entitlement request log that includes a plurality of prior entitlement requests. Performing anomaly detection may further include determining, based at least in part on the plurality of prior entitlement requests, that the first entitlement request is an outlier compared to the plurality of prior entitlement requests according to at least one anomaly detection metric. In response to determining that the first entitlement request is an outlier, the one or more processing devices may be further configured to output the user approval request to the user interface. The above features may have the technical effect of checking for potentially malicious or erroneous entitlement requests.

According to another aspect of the present disclosure, a method for use with a computing system is provided. The method includes executing a machine learning (ML) system including a plurality of ML agents. The plurality of ML agents include a first ML agent that has first entitlement metadata specifying a first entitlement domain that is accessible by the first ML agent and includes a plurality of resources. The method further includes receiving a first entitlement request including a selection of a resource included among the plurality of resources specified in the first entitlement domain. The first entitlement request further includes second entitlement metadata that specifies a second entitlement domain accessible by a second ML agent included in the ML system. Based at least in part on the first entitlement metadata and the second entitlement metadata, the method further includes granting the first entitlement request to thereby provide the second ML agent access to the selected resource. At the second ML agent, the method further includes computing an agent output based at least in part on the selected resource. The method further includes outputting the agent output to an additional computing process. The above features may have the technical effect of transferring access to the selected resource between different ML agents included in the ML system.

According to this aspect, the first entitlement domain may include a sub-entitlement domain that is specified as a proper subset of the first entitlement domain and includes the selected resource. The method may further include receiving, from the second AI agent, a second entitlement request including a selection of the selected resource. The second entitlement request may further include third entitlement metadata that specifies a third entitlement domain accessible by a third ML agent included in the ML system. Based at least in part on the selected resource being included in the sub-entitlement domain, the method may further include denying the second entitlement request. The above features may have the technical effect of making the selected resource non-transferable from the second ML agent to other ML agents.

According to this aspect, the ML system may include an access manager ML agent that includes a generative language model. The method may further include, at the access manager ML agent, determining that the selected resource is within the second entitlement domain at least in part by executing the generative language model with an access authorization checking prompt that includes the first entitlement metadata and the first entitlement request. The method may further include granting the first entitlement request in response to determining that the selected resource is within the second entitlement domain. The above features may have the technical effect of using the semantic processing capabilities of the generative language model to determine whether the first entitlement request is granted.

According to this aspect, the method may further include computing a confidence value of the determination that the selected resource is within the second entitlement domain. The method may further include granting the first entitlement request in response to determining that the confidence value is above a predefined confidence threshold. The above features may have the technical effect of determining whether to grant the first entitlement request based on a probabilistic determination of whether the selected resource is within the second entitlement domain.

According to this aspect, the first entitlement domain may further include a respective plurality of entitlement types associated with the resources. The entitlement types may be respective sets of available actions performable on the selected resource. The first entitlement request may further specify a selected entitlement type associated with the selected resource. The above features may have the technical effect of specifying what actions the second ML agent is granted permission to perform with the selected resource.

According to this aspect, the plurality of resources may include a file stored in a filesystem at one or more memory devices, a network location in a computer network, an input data stream received at the computing system, and/or an output interface of the computing system. The above features may have the technical effect of granting the second ML agent access to different types of resources.

According to this aspect, the method may further include outputting a user approval request to a user interface prior to granting the second ML agent access to the selected resource. The method may further include receiving a user approval response via the user interface subsequently to outputting the user approval request. The method may further include granting the second ML agent access to the selected resource in response to receiving the user approval response. The above features may have the technical effect of requesting user approval before granting the second ML agent access to the selected resource.

According to this aspect, the method may further include performing anomaly detection at the ML system at least in part by storing, in one or more memory devices, an entitlement request log that includes a plurality of prior entitlement requests. The method may further include determining, based at least in part on the plurality of prior entitlement requests, that the first entitlement request is an outlier compared to the plurality of prior entitlement requests according to at least one anomaly detection metric. In response to determining that the first entitlement request is an outlier, the method may further include outputting the user approval request to the user interface. The above features may have the technical effect of checking for potentially malicious or erroneous entitlement requests.

According to another aspect of the present disclosure, a computing system is provided, including one or more processing devices configured to execute a machine learning (ML) system including a plurality of ML agents. The plurality of ML agents include a first ML agent that has first entitlement metadata specifying a first entitlement domain that is accessible by the first AI agent and includes a plurality of resources. The first entitlement request further includes a sub-entitlement domain that is specified as a proper subset of the first entitlement domain. At an access manager ML agent included among the plurality of ML agents in the ML system, the one or more processing devices are further configured to receive a first entitlement request including a selection of a resource included in the sub-entitlement domain. The first entitlement request further includes second entitlement metadata that specifies a second entitlement domain accessible by a second ML agent included in the ML system. At least in part by executing a generative language model with an access authorization checking prompt that includes the first entitlement metadata and the first entitlement request, the one or more processing devices are further configured to determine that the selected resource is within the second entitlement domain. In response to determining that the selected resource is within the second entitlement domain, the one or more processing devices are further configured to grant the first entitlement request to thereby provide the second ML agent access to the selected resource. The one or more processing devices are further configured to receive, from the second AI agent, a second entitlement request including a selection of the selected resource. The second entitlement request further includes third entitlement metadata that specifies a third entitlement domain accessible by a third ML agent included in the ML system. Based at least in part on the selected resource being included in the sub-entitlement domain, the one or more processing devices are further configured to deny the second entitlement request. The above features may have the technical effect of transferring access to the selected resource between different ML agents included in the ML system. The above features may have the additional technical effect of making the selected resource non-transferable from the second ML agent to other ML agents.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
execute a machine learning (ML) system including a plurality of ML agents, wherein the plurality of ML agents include a first ML agent that has first entitlement metadata specifying a first entitlement domain that is accessible by the first ML agent and includes a plurality of resources;
receive a first entitlement request including:
a selection of a resource included among the plurality of resources specified in the first entitlement domain; and
second entitlement metadata that specifies a second entitlement domain accessible by a second ML agent included in the ML system;
based at least in part on the first entitlement metadata and the second entitlement metadata, grant the first entitlement request to thereby provide the second ML agent access to the selected resource; and
at the second ML agent:
compute an agent output based at least in part on the selected resource; and
output the agent output to an additional computing process.

2. The computing system of claim 1, wherein:
the first entitlement domain includes a sub-entitlement domain that is specified as a proper subset of the first entitlement domain and includes the selected resource; and
the one or more processing devices are further configured to:
receive, from the second ML agent, a second entitlement request including:
a selection of the selected resource; and
third entitlement metadata that specifies a third entitlement domain accessible by a third ML agent included in the ML system; and
based at least in part on the selected resource being included in the sub-entitlement domain, deny the second entitlement request.

3. The computing system of claim 1, wherein:
the ML system includes an access manager ML agent that includes a generative language model; and
at the access manager ML agent, the one or more processing devices are further configured to:
at least in part by executing the generative language model with an access authorization checking prompt that includes the first entitlement metadata and the first entitlement request, determine that the selected resource is within the second entitlement domain; and
grant the first entitlement request in response to determining that the selected resource is within the second entitlement domain.

4. The computing system of claim 1, wherein the one or more processing devices are further configured to:
compute a confidence value of the determination that the selected resource is within the second entitlement domain; and
grant the first entitlement request in response to determining that the confidence value is above a predefined confidence threshold.

5. The computing system of claim 4, wherein:
the predefined confidence threshold is included among a plurality of different predefined confidence thresholds associated with respective entitlement types; and
the entitlement types are respective sets of available actions performable on the selected resource.

6. The computing system of claim 4, wherein the predefined confidence threshold is included among a plurality of different predefined confidence thresholds associated with different respective resources of the plurality of resources.

7. The computing system of claim 3, wherein:
the one or more processing devices are configured to compute the first entitlement domain at least in part by executing the generative language model with an entitlement domain identification prompt that includes a semantic entitlement; and
the semantic entitlement has a natural language format.

8. The computing system of claim 1, wherein:
the first entitlement domain further includes a respective plurality of entitlement types associated with the resources;
the entitlement types are respective sets of available actions performable on the selected resource; and
the first entitlement request further specifies a selected entitlement type associated with the selected resource.

9. The computing system of claim 1, wherein the plurality of resources include:
a file stored in a filesystem at one or more memory devices;
a network location in a computer network;
an input data stream received at the computing system; and/or
an output interface of the computing system.

10. The computing system of claim 1, wherein the one or more processing devices are further configured to:
output a user approval request to a user interface prior to granting the second ML agent access to the selected resource;
receive a user approval response via the user interface subsequently to outputting the user approval request; and
grant the second ML agent access to the selected resource in response to receiving the user approval response.

11. The computing system of claim 10, wherein the one or more processing devices are further configured to:
perform anomaly detection at the ML system at least in part by:
storing, in one or more memory devices, an entitlement request log that includes a plurality of prior entitlement requests; and
determining, based at least in part on the plurality of prior entitlement requests, that the first entitlement request is an outlier compared to the plurality of prior entitlement requests according to at least one anomaly detection metric; and
in response to determining that the first entitlement request is an outlier, output the user approval request to the user interface.

12. A method for use with a computing system, the method comprising:
executing a machine learning (ML) system including a plurality of ML agents, wherein the plurality of ML agents include a first ML agent that has first entitlement metadata specifying a first entitlement domain that is accessible by the first ML agent and includes a plurality of resources;
receiving a first entitlement request including:
a selection of a resource included among the plurality of resources specified in the first entitlement domain; and
second entitlement metadata that specifies a second entitlement domain accessible by a second ML agent included in the ML system;
based at least in part on the first entitlement metadata and the second entitlement metadata, granting the first entitlement request to thereby provide the second ML agent access to the selected resource; and
at the second ML agent:
computing an agent output based at least in part on the selected resource; and
outputting the agent output to an additional computing process.

13. The method of claim 12, wherein:
the first entitlement domain includes a sub-entitlement domain that is specified as a proper subset of the first entitlement domain and includes the selected resource; and
the method further comprises:
receiving, from the second ML agent, a second entitlement request including:
a selection of the selected resource; and
third entitlement metadata that specifies a third entitlement domain accessible by a third ML agent included in the ML system; and
based at least in part on the selected resource being included in the sub-entitlement domain, denying the second entitlement request.

14. The method of claim 12, wherein:
the ML system includes an access manager ML agent that includes a generative language model; and
the method further comprises, at the access manager ML agent:
at least in part by executing the generative language model with an access authorization checking prompt that includes the first entitlement metadata and the first entitlement request, determining that the selected resource is within the second entitlement domain; and
granting the first entitlement request in response to determining that the selected resource is within the second entitlement domain.

15. The method of claim 12, further comprising:
computing a confidence value of the determination that the selected resource is within the second entitlement domain; and
granting the first entitlement request in response to determining that the confidence value is above a predefined confidence threshold.

16. The method of claim 12, wherein:
the first entitlement domain further includes a respective plurality of entitlement types associated with the resources;
the entitlement types are respective sets of available actions performable on the selected resource; and
the first entitlement request further specifies a selected entitlement type associated with the selected resource.

17. The method of claim 12, wherein the plurality of resources include:
a file stored in a filesystem at one or more memory devices;
a network location in a computer network;
an input data stream received at the computing system; and/or
an output interface of the computing system.

18. The method of claim 12, further comprising:
outputting a user approval request to a user interface prior to granting the second ML agent access to the selected resource;
receiving a user approval response via the user interface subsequently to outputting the user approval request; and
granting the second ML agent access to the selected resource in response to receiving the user approval response.

19. The method of claim 18, further comprising:
performing anomaly detection at the ML system at least in part by:
storing, in one or more memory devices, an entitlement request log that includes a plurality of prior entitlement requests; and
determining, based at least in part on the plurality of prior entitlement requests, that the first entitlement request is an outlier compared to the plurality of prior entitlement requests according to at least one anomaly detection metric; and
in response to determining that the first entitlement request is an outlier, outputting the user approval request to the user interface.

20. A computing system comprising:
one or more processing devices configured to:
execute a machine learning (ML) system including a plurality of ML agents, wherein the plurality of ML agents include a first ML agent that has first entitlement metadata specifying:
a first entitlement domain that is accessible by the first ML agent and includes a plurality of resources; and
a sub-entitlement domain that is specified as a proper subset of the first entitlement domain; and
at an access manager ML agent included among the plurality of ML agents in the ML system:
receive a first entitlement request including:
a selection of a resource included in the sub-entitlement domain; and
second entitlement metadata that specifies a second entitlement domain accessible by a second ML agent included in the ML system;
at least in part by executing a generative language model with an access authorization checking prompt that includes the first entitlement metadata and the first entitlement request, determine that the selected resource is within the second entitlement domain; and
in response to determining that the selected resource is within the second entitlement domain, grant the first entitlement request to thereby provide the second ML agent access to the selected resource;
receive, from the second ML agent, a second entitlement request including:
a selection of the selected resource; and
third entitlement metadata that specifies a third entitlement domain accessible by a third ML agent included in the ML system; and
based at least in part on the selected resource being included in the sub-entitlement domain, deny the second entitlement request.
